(19) United States
(12) Patent Application Publication
(10) Pub. No.: US 2007/0051148 A1
(43) Pub. Date: Mar. 8, 2007

(54) Fertilizer compositions

(75) Inventor: Domenico Terenzio, Fondi (IT)

Correspondence Address: MERCHANT & GOULD PC, P.O. BOX 2903, MINNEAPOLIS, MN, 55402-0903, US

(73) Assignee: Fertirev S. r.l., Torino (IT)

(21) Appl. No.: 10/560,081

(22) PCT Filed: Jun. 10, 2004
(86) PCT No.: PCT/IB04/01905

§ 371 Date: Dec. 8, 2005

(30) Foreign Application Priority Data
Jun. 13, 2003 (IT) LT2003A000006
Jun. 13, 2003 (IT) 2003A000007
Jun. 13, 2003 (IT) LT2003A000008

(51) Int. Cl. C05F 11/02

(52) U.S. Cl. 71/24

(57) ABSTRACT

A process for preparing a fertilizer composition, characterized in that it comprises the following steps: a) reacting a humified fossil material, which is selected from the group comprising leonardite, lignite, xylite and peat, in water in the presence of gluconic acid; and b) subsequently adding to the mixture an alkaline agent in such a quantity as to adjust the pH to a basic value.

The present invention relates to a process for preparing a fertilizer composition using fossil materials having a high content of humic acids, in particular leonardite ore, and fertilizer compositions obtained in this manner.

Leonardite is an oxidized form of lignite which has for some time been used as a source of organic materials, in particular humic and fulvic acids, and which is intended for use as an additive for treating soil for regulating plant growth.

U.S. Pat. No. 4,698,090 describes a process for preparing a liquid composition which is used to modify plant growth, wherein a leonardite ore is reacted with an organic chelating agent in an aqueous medium at a temperature of between 77° C. and 107° C. The chelating agents used are ammonium or metal salts of hydroxy acids, such as in particular gluconic, glucoheptoic, tartaric, tartronic, galactaric, glucaric, glutaric and glutamic acid, or glutamines and synthetic organic chelating agents, such as EDTA.

Following the reaction, the process optionally provides for the adjustment of the pH by addition of sodium or potassium hydroxide and the separation of the liquid phase which is used as the fertilizer.

U.S. Pat. No. 4,786,307 describes a process for preparing micronutrient liquid compositions, wherein the product of the extraction of leonardite ore in water with a chelating agent, which is constituted by a hydroxy acid salt, at a pH greater than 2.5, is combined with a cationic metal salt of a micronutrient metal in the presence of a hydroxy acid with subsequent addition of anhydrous ammonia to the reaction mixture in order to adjust the pH to values of from 7.5 to 9.

The present invention relates to an improved process for preparing a fertilizer in liquid or solid form having improved properties and a wide range of applications.

In particular, the invention relates to a process for preparing a fertilizer composition which is characterized in that it comprises steps for reacting a fossil material, which has a high level of humification and which is selected from the group comprising leonardite, lignite, xylite and peat, in water with gluconic acid and subsequently carrying out the extraction of the humic substances by adding to the mixture an alkaline agent, preferably potassium hydroxide or ammonium hydroxide until a basic pH is reached, preferably a pH greater than 9.

The invention further relates to a fertilizer composition which can be obtained by the above-mentioned process; this fertilizer composition which contains the reaction product of gluconic acid with humic and/or fulvic acids which are contained in the fossil material and which are extracted with ammonium or potassium hydroxide, will be referred to below using the term glucohumate complex.

The preferred fossil material having a high level of humification is leonardite, preferably having a content of humic acids of greater than 80% by weight. Reference is made below to the use of leonardite as a preferred material, it being appreciated that the other fossil materials mentioned above can also be used.

In the first step of the process according to the invention, the finely ground leonardite—for example, having sieving dimensions of between 50 and 300 μm—is mixed in water, preferably demineralized water or spring water having a low sodium and sulphur content; the quantity of leonardite relative to water is generally between 20% and 35% by weight and in any case sufficient to obtain a mixture or suspension which can be kept under agitation.

Gluconic acid of technical grade (typically a 50% solution of gluconic acid in water) is then added to the mixture of leonardite and water, with the mixture being lightly agitated.

The first reaction step in water, in the presence of gluconic acid, is preferably carried out while keeping the suspension at a temperature of less than 60° C., more preferably at between 15° C. and 30° C. The quantity of gluconic acid added, expressed as a 50% solution of gluconic acid by weight, is typically of from 3% to 10% by weight in relation to the weight of the leonardite or other fossil material used, such that the pH of the suspension—further acidified owing to the addition of the gluconic acid—is generally of between 2 and 3, and preferably less than 2.5.

The mixture obtained in this manner is agitated usually for a time of from 2 to 4 hours and is optionally left in a stationary state for approximately from 6 to 12 hours, at a temperature preferably of between 17° C. and 30° C.

Afterwards, there is added to the mixture an alkaline extracting agent, preferably potassium or ammonium hydroxide, typically in such a quantity as to obtain a pH greater than 9 and preferably greater than 11. Typically, the quantity of potassium hydroxide, expressed as potassium hydroxide at 48-50% by weight, is from 6% to 15% by weight, relative to the weight of the leonardite.

The mass is then agitated for a time of from 6 to 12 hours, followed by an optional period of up to 24 hours in a stationary state.

In a first embodiment, the product obtained in this manner can be subjected to drying and granulation in order to obtain a granular product for use as a fertilizer.

Alternatively, filtration is carried out to separate the liquid phase which can be used as such state in localized fertilization by irrigation.

In a preferred embodiment, the properties of the fertilizer composition obtained can be further improved by addition of urea, with a product referred to hereinafter as urea glucohumate being obtained.

In one embodiment, urea can be added following completion of the reaction with potassium or ammonium hydroxide which ensures the extraction of the humic substances (humic acids, fulvic acids and humic matter).

In this case, urea is added to the mixed mass at a quantity of from 10 to 60% of the leonardite used, the mass being agitated for from 3 to 6 hours in order to allow a bond to be produced between the ureic nitrogen and the organic mass. Afterwards, the product is conveyed to a drying and granulating plant. Alternatively, the mass obtained in this manner can be further diluted with water in a quantity sufficient to obtain a suspension which can be filtered until a preparation in liquid form is obtained for use by application to leaves and localized fertilization by irrigation.

Alternatively, urea can be added to the liquid phase obtained by filtration of the reaction product with potassium or ammonium hydroxide.

In this case, the quantity of urea is typically between 20% and 60%, preferably from 50 to 60% by weight relative to the weight of the liquid phase.

The composition according to the invention can further comprise other macronutrients and micronutrients which are preferably added to the mixture following the addition and at completion of the reaction with ammonium or potassium hydroxide. In particular, the macronutrients can comprise:
phosphates (polyphosphates);
potassium salts (carbonate inter alia);
calcium salts (carbonate, phosphate inter alia);
magnesium salts (carbonate inter alia).

The micronutrients can comprise:
compounds of zinc, such as zinc oxide or organic zinc salts;
iron salts;
manganese salts, copper salts, boron compounds, compounds of molybdenum and cobalt.

Typically, the quantity of macroelements and microelements is less than 15% by weight of the weight of the fertilizer composition.

Furthermore, the composition can preferably comprise plant extracts, such as, in particular, extracts of castor beans and lupin seeds, generally in a quantity not greater than 20% by weight of the composition, preferably at a proportion of from 15 to 20% by weight.

According to another feature of the invention relating to granular absorbent materials, preferably comprising the above-mentioned micronutrients and macronutrients and/or the aforementioned castor and lupin extracts, the compositions according to the invention are converted into compositions having a high level of water retention by super-absorbent polymers being added to the granules, generally being used in a quantity of from 10% to 50%, preferably from 10% to 25% relative to the weight of the composition.

Suitable super-absorbent materials comprise in particular starch hydrolysates and polyacrylonitrile.

The process and the composition according to the invention are further illustrated by the examples below.

### EXAMPLE 1

### Glucohumate Complexes

In this example and the examples below, an American leonardite (North Dakota or New Mexico) is used and has the following mean analytical values, expressed as percentages by weight:

| | |
|---|---|
| Organic carbon of biological origin | 52% |
| Organic nitrogen | 0.75% |
| Total organic substance | 90% |
| Extractable organic substance as percentage of the | 85% |
| total organic substance | |
| Humified organic substance as percentage of the | 93% |
| extractable organic substance | |
| pH in water | 3-3.5 |

The leonardite, which is finely ground, preferably with a peg type mill at a speed of from 8000-12000 revolutions per minute, is introduced into a rotary mixer (of the concrete mixer type) and then water is added until a slightly “muddy” mixture is produced; gluconic acid (50% concentration) is added at a percentage of from 5 to 8% by weight of the leonardite and is mixed slowly for approximately 2 hours; the entire mass is left in a stationary state for approximately from 6 to 12 hours at a temperature of between 17° C. and 30° C.; afterwards, the liquid potassium hydroxide, at a concentration of from 48 to 50%, is added at a percentage of from 6 to 15% by weight of the leonardite used in the mixture and is left being slowly agitated for approximately from 6 to 12 hours (depending on the temperatures).

The product obtained in this manner is transferred to a rotary drying and granulating plant in order to obtain a natural organic fertilizer in granulated form.

Alternatively, the same mixture can, instead of being conveyed to the drying and granulating plant, be filtered after suitable dilution in water in a suitable centrifuge in order to obtain a liquid fertilizer composition which is intended in particular for use in localized fertilization by irrigation.

### EXAMPLE 2

The process is as in Example 1, using ammonium hydroxide at a concentration of 28 Bé in place of potassium hydroxide.

The glucohumate complexes obtained according to the above-described process, in particular in solid, granular form, are programmed-release fertilizers which are useful for increasing the fertility of agricultural soils and, in addition, for decontaminating soils which have been polluted by chemical products and/or toxic metal ions.

In particular, their use leads to technical, agronomical and environmental advantages which can be summarized as follows:
1. high levels of activity in decontaminating soils which are polluted by chemical products (chlorine derivatives, bromine derivatives, etc.), by toxins, toxic metal ions, with an improvement in the physical, chemical and biological characteristics of the soil;
2. marked increase in the fertility of soils which are impoverished or have not been subjected to crop rotation, sandy soils, salty soils having high conductivity;
3. release of all the fertility elements present in the soil, with an increase in the capacity for cationic exchange of the soil;
4. introduction to the soil of an organic substance having a high level of humification, readily available to plants;
5. increase in all of the biochemical activities of the soil;
6. increase in the chlorophyll photosynthesis processes of plants;
7. increase in the resistance of plants to stress owing to adverse pedological climatic factors;
8. increase in the germination of seeds;
9. marked reduction (up to 70%) in the use of mineral and chemical fertilizers in soil;
10. total elimination of the introduction of nitrates to the soil in conventional nutritional techniques for plants;
11. marked improvement in agricultural products in terms of quality and quantity;
12. increase in the content of sugars, vitamins, mineral salts and carotenoids (licopenes) in fruit and vegetables;
13. reduction in the growth cycle of plants, with the sales period of the fruit and vegetables being brought forward accordingly;
14. increase in the self-defense barriers of plants from attacks by parasites of the fungal and bactericidal type;
15. provision of soil for cultivation which is always fertile and productive;
16. total absence of fermentation processes from the organic substance administered, because it is completely mineralized;
17. high levels of antimicrobial action owing to the presence of gluconic acid in the preparation;
18. total elimination of pollution of groundwater owing to leaching of mineral salts;
19. maximum guarantee of fruit and vegetable production, free from toxic elements and/or polluting chemical products.

Therefore, the compositions are used depending on the above-mentioned features and advantages to be obtained.

### EXAMPLE 3

### Urea Glucohumate

75 litres of preferably demineralized water and 20 kg of finely ground leonardite are introduced into a dissolution device and are then agitated slowly with addition of 100 cm³ of silicone antifoaming agent and 4 kg of gluconic acid at 50% by weight, with the whole mixture being agitated for approximately from 3 to 4 hours (depending on the working temperatures).

Once this time has passed, 6 kg of potassium hydroxide in the form of flakes are added to the mass, the entire mass being agitated rapidly for 6 hours. The mass is left in a stationary state for 24 hours, after which the separation of the liquid phase (colloid suspension) from the solid phase is carried out by centrifuging. Some of the liquid phase (40 kg) is transferred to a second dissolution device which is provided with agitators, where ureic nitrogen is added at a quantity of 60 kg of liquid ureic nitrogen with the ureic nitrogen titre of 30%. The product obtained in this manner is then placed in containers of non-transparent polyethylene and is ready for use.

The product obtained has the following final mean composition:

| | |
|---|---|
| Total organic substance from leonardite: humified | 5.93% |
| organic substance | |
| Potassium: potassium oxide (K₂0) soluble in water | 4.51% |
| Gluconic acid | 0.83% |
| Total nitrogen | 18.05% |
| Ureic nitrogen | 18.00 |

As an alternative to the above-described process, the same quantity of ureic nitrogen is added directly to the mixed mass of the first dissolution device and is agitated slowly for from 3 to 6 hours.

The product is then conveyed to a drying and granulating plant in order to obtain a granular fertilizer.

In particular, the use of the above-described fertilizer compositions (urea glucohumate) allows the disadvantages to be overcome relating to the use of urea which constitutes the most common nitrogenous fertilizer.

The greatest disadvantage relating to the use of urea is constituted by its low persistence in soil which, on average, is in the order of from 15 to 20 days depending on the type of soil and the geo-environmental temperatures. Another negative feature of the urea fertilizer is its high toxicity which can appear in the vegetation, in the presence of conditions, such as high pH value, high temperatures and high conductivity.

In particular, the use of urea glucohumate includes the following technical and agronomical advantages:
a. marked increase in the persistence of ureic nitrogen in the soil, which—depending on the induced ratios thereof with the glucohumic substances present in the formulation—can reach up to 4 months;
b. total elimination of the risks of phytotoxicity of the urea;
c. slow, continuous and protected release of the ureic nitrogen, without problems of leaching;
d. greatly reduced release of ammonia in the soil after use of the preparation;
e. reduction (of up to 50%) of the fertilizing units in terms of nitrogen in the crops, owing to the total absence of losses owing to leaching and/or adverse pedological factors;
f. use of the formulation in all types of cultivation, both extensive and intensive, in open fields and for protected cultivation, independently of the technical, agronomical or thermoenviromental conditions;
g. possibility of administering the localized product to the plants (in the rows for cultivation);
h. use on lawns, specialized flower cultivations, nursery cultivations, potted plants;
i. introduction of mineralized organic substance having a high level of humification to the plants;
l. improvement in the physical, chemical and biological characteristics of the soil.

The liquid urea glucohumates which are the subject-matter of Example 3 have been used:
for fertilization by irrigation in greenhouses and in fields in quantities of from 10 to 15 kg/1000 m² of surface area, every 8 to 10 days; and
for spraying leaves in quantities of from 5 to 6 kg/1000 litres of water, every 10 to 12 days.

Preliminary tests carried out in fields on vegetables relating to the cultivation of cucurbitaceous plants, celery, salad leaves, radishes and tomatoes, have demonstrated an increase in production of between 10% and 20%, a qualitative improvement of between 10% and 25% and an increase in resistance to fungal attacks in the order of from 20 to 25% as compared with non-treated crops.

### EXAMPLE 4

### Glucohumates Having a High Level of Water Retention

The process is carried out as in Example 3 and, after the addition of potassium hydroxide and the mixture has been agitated slowly for 12 hours, other nutritional elements (macroelements and microelements) are added to the “muddy” mass in quantities not greater than 15% of the mass being processed; plant extracts of castor beans and lupin seeds are then added at a proportion of from 15 to 20% of the total mass processed.

Afterwards, the product is conveyed to a drying and granulating plant. At the outlet from the granulating plant, the granules obtained in this manner are transferred to a mixer, in the absence of air, where the super-absorbent substance is added (derivatives of hydrolyzed starch) at a proportion of from 15 to 25% of the mass being processed.

The super-absorbent substances are fixed to the exterior of the fertilizer granules and then vacuum-packed in order to prevent the absorption of ambient moisture.

It will be appreciated in the example described that the addition of nutritional elements and the castor and lupin extracts is optional.

The granular compositions obtained in this manner are used in particular as fertilizers, in particular for cultivation in arid zones. The salient features of the composition are:
i. good retention of water, originating from irrigation or ambient moisture, which is always available in the region of the root system;
ii. a great reduction in the phenomena of leaching from the soil because the granular fertilizing material captures the water present, swelling in volume to up to 150 times its weight;
iii. balanced nutrition of the plants, with uninterrupted availability of the mineral salts contained in the preparation, which are always ready to be used by the plants in a stable gelatinous solution;
iv. a clear soil conditioning action with an improvement in the physical state owing to the hyper-aeration of the soil particles, following the increase in the mass of the granules;
v. introduction of all of the nutritional elements which are indispensable for the metabolic functions of the plants;
vi. elimination of the shock of transplantation for the young plants;
vii. marked reduction in the occurrences of irrigation;
viii. potential for development of the root systems of the plants;
ix. introduction of the active ingredients of plant origin contained in the castor beans and lupin seeds, which further have a strong repelling action in respect of terrestrial insects and hypogeous nematodes, in addition to the introduction of protein substances having a high content of organic nitrogen;
x. great reduction in the introduction of nutritional elements (N, P, K and oligoelements) to the soil; non-leachability of the nutritional elements contained in the granules because they are protected inside the gelatinous mass which is produced in the presence of moisture;
xi. possibility of cultivation in arid and desert territories or in soils having high conductivity, because the ambient moisture alone (which is produced in those territories during the hours of the night) allows systematic cultivation of species of agro-alimentary interest.

The granules of the fertilizer composition can generally have dimensions of between 0.5 mm and 1 cm and are able to absorb from 150 to 200 times their own weight in accordance with the super-absorbent gelatinous substance present therein.

1. A process for preparing a fertilizer composition, comprising the following steps:
reacting a humified fossil material, which is selected from the group comprising leonardite, lignite, xylite and peat, in water in the presence of gluconic acid; and
subsequently adding to the mixture an alkaline agent in such a quantity as to adjust the pH to a basic value.

2. A process according to claim 1, wherein the quantity of gluconic acid added, expressed as gluconic acid at 50% by weight, is from 3% to 10% by weight relative to the weight of the fossil material.

3. A process according to claim 1 wherein the alkaline agent is potassium hydroxide or ammonium hydroxide.

4. A process according to claim 1, wherein the alkaline agent is potassium hydroxide, added at a quantity of from 6% to 15% by weight relative to the weight of the fossil material, said quantity being expressed as potassium hydroxide at from 48-50% by weight.

5. A process according to claim 1, wherein the gluconic acid is added in such a quantity as to adjust the pH to values of less than 3 and preferably less than 2.5.

6. A process according to claim 1, wherein step a) is carried out at a temperature not greater than 30° C.

7. A process according to claim 1, wherein step a) is continued for a time of from 2 to 4 hours with agitation, which is followed by an optional stationary period for a time of from 6 to 12 hours.

8. A process according to claim 1, wherein, in step b), agitation is continued for a time of from 6 to 12 hours, followed by an optional stationary period of up to 24 hours.

9. A process according to claim 1, comprising the addition of macronutrient and micronutrient substances to the product of step b).

10. A process according to claim 9, comprising the addition of urea in quantities of from 10% to 60% relative to the weight of the fossil material.

11. A process according to claim 9 comprising the addition of plant extracts, in particular extracts of castor beans and lupin seeds.

12. A process according to claim 1, wherein the product obtained by step b) is subjected to drying and granulation in order to produce a composition in granular form.

13. A process according to claim 12, wherein the granular composition is mixed with super-absorbent polymer substances, in particular derivatives of hydrolyzed starch, for preparing a granular composition having a high level of water retention.

14. A process according to claim 1, wherein the product of step b) is subjected to filtration with separation of the liquid phase which is intended for use as a liquid fertilizer.

15. A process according to claim 14, characterized in that wherein the liquid phase obtained by the filtration is supplemented with urea in quantities of from 20% to 60% relative to the weight of the liquid phase.

16. A process according to claim 1, wherein the fossil material is a leonardite ore.

17. Fertilizer compositions in liquid form, which can be obtained by means of the process according to claim 1.

18. Fertilizer compositions in granular form, which can be obtained by means of the process according to claim 1.

19. A granular composition according to claim 18 wherein the composition is used as a fertilizer, in particular for increasing plant growth.

20. A granular composition according to claim 18 wherein the composition is used to increase the fertility of agricultural soils or to decontaminate soils polluted by chemical products and/or toxic metal ions.

21. A liquid composition according to claim 17 wherein the composition is used to fertilize by localized irrigation and/or by spraying leaves.
